(19) United States
(12) Patent Application Publication
(10) Pub. No.: US 2006/0232211 A1
(43) Pub. Date: Oct. 19, 2006

(54) Method of manufacturing a lamp

(75) Inventors: Wilhelmus Jacobus Johannes Welters, Eindhoven (NL); Marten Willem Schuiteman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/554,377

(22) PCT Filed: Apr. 28, 2004
(86) PCT No.: PCT/IB04/50541

§ 371 Date: Oct. 26, 2005

(30) Foreign Application Priority Data
May 1, 2003 (EP) 031101204.0

(51) Int. Cl. H01J 61/35; H01J 17/16

(52) U.S. Cl. 313/635

(57) ABSTRACT

Method of manufacturing a lamp comprising a transparent vessel containing a gas filling, a luminous element or an electrode extending inside the vessel and connected to a lead wire extending through a pinched portion of the vessel, which lead wire is provided with a protective coating obtained by applying a liquid to the outside of the pinched portion where the lead wire extends from said pinched portion, characterized in that said liquid is a solution of a compound comprising a positive ion of a material chosen for its propensity to react with oxidized lead wire material so as to form the protective coating.

The invention relates to a method of manufacturing a lamp comprising a transparent vessel containing a gas filling, a luminous element or an electrode extending inside the vessel and connected to a lead wire extending through a pinched portion of the vessel, which lead wire is provided with a protective coating obtained by applying a liquid to the outside of the pinched portion where the lead wire projects from said pinched portion. The invention can advantageously be applied to a gas discharge lamp, in which case the lead wire is connected to an electrode, as well as to a halogen lamp, in which case the lead wire is connected to a luminous element. Although in this application the wording “pinched portion” is used, this is to be understood to comprise any sealed portion of the vessel as well.

Such a method is known from U.S. Pat. No. 4,835,439. The current feed-through in quartz or hard-glass burners or lamps is easily oxidized at the high temperatures that occur during the use of the burners. The oxidation often occurs in the capillary between the quartz or glass and the lead-out wire in the pinched portion, because the surface of the lead wire is exposed to both air and high temperatures if the lamp is on. The oxidation can be slowed down by the use of coatings, which is often referred to as “pinch protection”.

In the method to which this invention relates, a liquid is applied to the outer end of each seal at the outer lead wire, resulting in the liquid penetrating into the capillary cavity between the glass and the outer lead. In the known method, the liquid is an alkali metal silicate solution, such as sodium silicate or “water-glass”, and the lamp has to be dried in an oven afterwards in order for the alkali metal silicate to form a protective layer. As in many lamp types, the lead wire of the lamp described in this document is mounted on a molybdenum strip extending inside the pinched portion, wherein the liquid reaches the mounting area through capillary action along the lead wire, thereby providing a protective coating on the mounting area and the strip.

Although this is a simple manner of forming a protective layer on the lead wire and any possible metal parts connected thereto, sodium silicate, also known as water-glass, is known to react with the quartz or glass material of the pinch, having a negative impact on the hardness thereof and resulting in possible cracks.

The object of the invention is to provide an alternative inexpensive and effective method of manufacturing a lamp having a long life time, and in particular to protect metal parts of the lamp against corrosion in a cheaper, simpler, and/or more effective manner.

In order to accomplish this, the liquid applied to the pinched portion is a, preferably aqueous, solution of a compound comprising a positive ion of a material chosen for its propensity to react with oxidized lead wire material so as to form the protective coating. The protective layer thus bonds to the lead wire material, not to the pinch material. Another advantage is that there is no need to dry the lamp in an oven, because as opposed to the known method the water will evaporate at room temperature.

Said lead wire may be made, for example, of molybdenum, tungsten, rhenium or tantalum, and said positive ion forming material may be, for example, chosen from the group of silver, gold, cobalt, nickel, palladium, rhodium and ruthenium. For example: silver reacts with molybdenum oxide and forms a silver-molybdenum oxide phase, probably in the form of AgMoO₄ or other possible phases, which mixture is fluid when heated to a working temperature of more than approximately 400° C., thereby forming a very efficient protective layer on the lead wire.

Combinations of materials which are widely used for lamps are quartz glass for the pinched portion and molybdenum for said lead wire, or alternatively hard glass for the pinched portion and tungsten for the lead wire. The invention can be applied to both types of lamps.

Preferably, the negative ion of the compound is chosen to disintegrate at a temperature of 425° C., preferably 400° C., more preferably 375° C., even more preferably 350° C., leaving only the positive ion forming material, whereby any disadvantageous reaction is prevented. Examples thereof are NO₃ and ClO₃. Extensive tests carried out with a silver nitrate solution on a molybdenum/quartz combination gave very positive results.

The invention also relates to a lamp provided with a protective coating obtained by the above described method.

These and other aspects of the invention are apparent from and will be elucidated with reference to the embodiments described hereinafter.

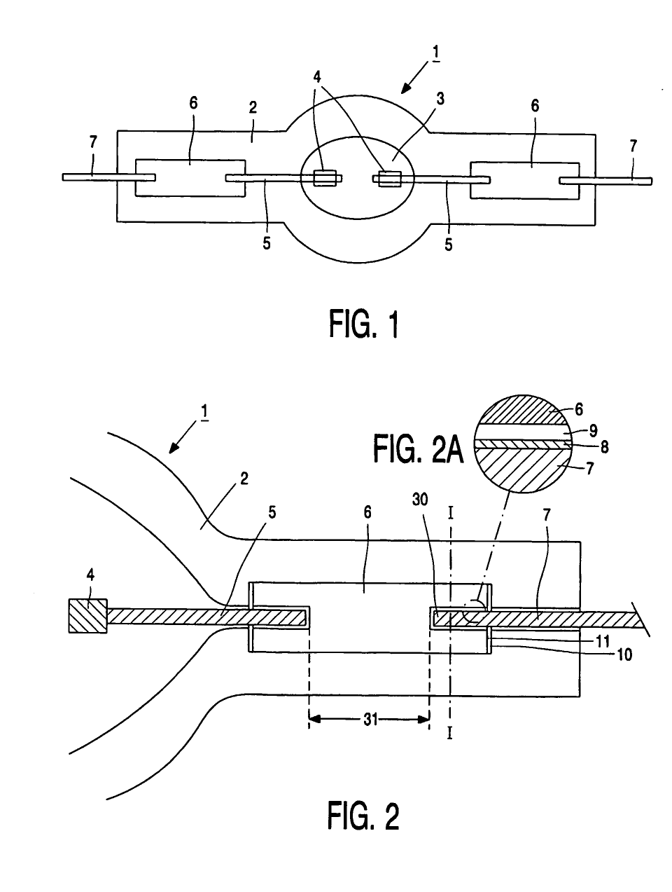

FIG. 1 shows a lamp according to the invention in a plan view;

FIGS. 2-2A show details of a seal of the lamp of FIG. 1;

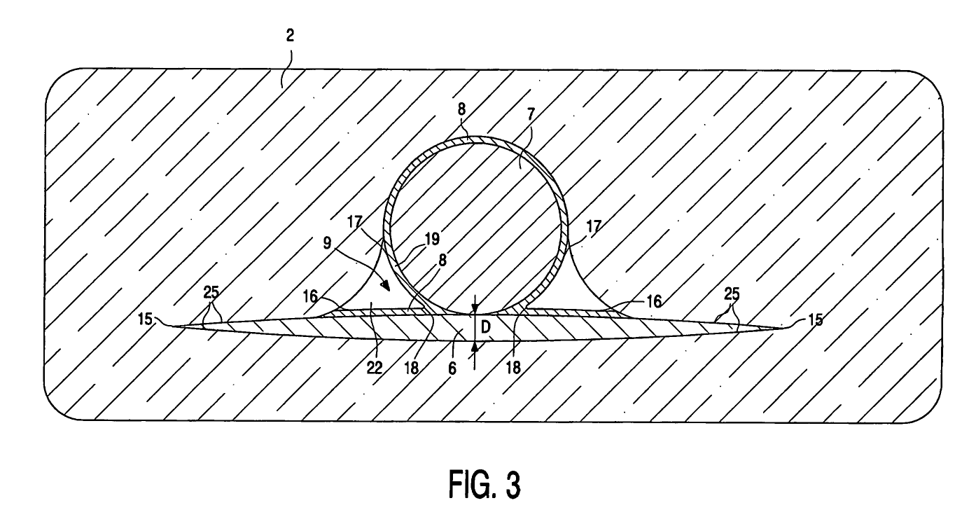

FIG. 3 is a cross-section taken on the line I-I of a seal of the lamp shown in FIG. 1.

In FIG. 1, the electric lamp is a high-pressure gas discharge lamp having a lamp vessel 1 which is closed in a vacuumtight manner and a quartz glass wall 2 enclosing a space 3. The electric element 4 is connected via a respective internal lead wire 5 to a respective molybdenum foils 6 and projects from the wall 2 of the lamp vessel 1 into the space 3. The metal foils 6 are embedded in a pinched portion of the wall 2 of the lamp vessel 1, and a respective external molybdenum lead wire 7 is mounted thereon, for example by welding.

The internal lead wires 5 and the electric element 4 are made of tungsten. An ionizable filling is present in the space 3. The lamp vessel 1 is filled with mercury, rare gas and halides of dysprosium, holmium, gadolinium, neodymium and cesium. The lamp shown in the Figure consumes a power of 700 W during operation.

FIGS. 2-2A show that the external current conductors 7 have a protective coating 8, which shields the external lead wire 7 and a capillary 9 around the external lead wires 7 from each other. It has been indicated that the capillary 9 terminates at an end 30 of the external lead wire 7. It has further been indicated that a capillary 10 is present at a head end 11 of the metal foil 6. The capillaries 9 and 10 are in open connection with the atmosphere outside the lamp, the protective coating 8 preventing a too rapid corrosion of at least the mounting area between the metal foil 6 and the external lead wire 7. The seal is vacuumtight at the area of the metal foil 6 in a zone 31 between the external lead wire 7 and the internal lead wire 5.

FIG. 3 is a cross-section of the seal shown in FIGS. 2-2A, taken on the line I-I. The figure shows that the metal foil 6 has a greatest thickness D. There is no capillary at the knife edges 15 formed by the knife edge surfaces 25 of the metal foil 6. The capillary 9 around the external lead wire 7 has a hollow space 22 which communicates with the atmosphere outside the lamp.

Notably the corners 16, 17 and 18 are critical areas as far as corrosion of the metal foil 6 and the external lead wire 7 is concerned. At these areas, there is no possibility of expansion in the hollow space 22 due to corrosion. A small expansion of the metal foil 6 and/or the external lead wire 7 in the corners 16, 17 and 18 will thus result in high tensile stresses in the wall 2. Moreover, the corrosion of the metal foil 6 and the external lead wire 7 and the accompanying expansion have a wedge effect due to the acute angles at which the quartz glass engages the metal foil 6 and the external lead wire 7.

The air-exposed surfaces of the external lead wire 7 and of the metal foil 6 are provided with the protective coating 8 in the following manner. A liquid is applied to the outside of the pinched portion of the wall 2, where the external lead wire 7 projects from the pinched portion. The liquid will enter the capillary 9 and the hollow space 22 by capillary action. The liquid is, for example, a 1-mole/l aqueous solution of silver nitrate, in an amount of approximately 10 μmole silver nitrate per lead wire 7. The solution thus comprises a positive ion of a material, in this case silver, which is chosen for its tendency to react with the oxidized molybdenum lead wire and foil material so as to form a protective coating thereon, and a negative ion, in this case NO₃, which is chosen to disintegrate at a temperature below approximately 400° C. The water of the aqueous solution will simply evaporate by drying at room temperature.

When the lamp is on, the temperature in the pinched portion will rise to above 400° C. At this temperature the nitrate will disintegrate and disappear. The silver will react with molybdenum oxide and form a silver oxide/molybdenum oxide phase mixture. This reaction material is fluid at temperatures above 400° C. and will thus form the fluid protection layer 8a. Being fluid, the protection layer 8a will distribute itself evenly over the surface of the corrosive heated metal portions inside the capillary 9. When the lamp cools down, the silver will be partly segregated again and form a solid material which does not need to be evenly distributed over the entire surface per se.

Although the invention was described above with reference to a specific lamp type, it will be clear to those skilled in the art that it may be applied to many other lamp types as well.

1. Method of manufacturing a lamp comprising a transparent vessel (1) containing a gas filling, a luminous element or an electrode (4) extending inside the vessel (1) and connected to a lead wire (7) extending through a pinched portion of the vessel (1), which lead wire (7) is provided with a protective coating (8) obtained by applying a liquid to the outside of the pinched portion where the lead wire (7) projects from said pinched portion, characterized in that said liquid is a solution of a compound comprising a positive ion of a material chosen for its propensity to react with oxidized lead wire material so as to form the protective coating (8).

2. Method according to claim 1, wherein the negative ion of the compound is chosen to disintegrate at a temperature of 425° C., preferably 400° C., more preferably 375° C., even more preferably 350° C.

3. Method according to claim 1, wherein said positive ion forming material is chosen from the group of Ag, Au, Co, Ni, Pd, Rh and Ru.

4. Method according to claim 1, wherein said negative ion is chosen from the group of NO₃ and ClO₃.

5. Method according to claim 1, wherein said lead wire (7) is made of Mo, W, Re or Ta.

6. Method according to claim 1, wherein said pinched portion is made of quartz glass and said lead wire (7) is made of Mo, or said pinched portion is made of hard glass and said lead wire (7) is made of W.

7. Method according to claim 1, wherein said lead wire (7) is mounted on a Mo strip (6) extending inside said pinched portion, and wherein said liquid reaches the mounting area through capillary action along the lead wire (7), thereby providing a protective coating on said mounting area.

8. Method according to claim 1, wherein said compound is AgNO₃.

9. Method according to claim 1, wherein said lamp is a halogen lamp.

10. A lamp comprising a transparent vessel (1) containing a gas filling, a luminous element or an electrode (4) extending inside the vessel (1) and connected to a lead wire (7) extending through a pinched portion of the vessel (1), provided with a protective coating (8) by the method according to claim 1.
